(19) United States
(12) Patent Application Publication
(10) Pub. No.: US 2002/0076543 A1
(43) Pub. Date: Jun. 20, 2002

(54) Layered dielectric nanoporous materials and methods of producing same

(76) Inventor: John G. Sikonia, Morgan Hill, CA (US)

Correspondence Address: Honeywell International Inc., Law Dep. AB2, P.O. Box 2245, 101 Columbia Road, Morristown, NJ, 07962, US

(21) Appl. No.: 09/741,634

(22) Filed: Dec. 19, 2000

(51) Int. Cl. B32B 3/26

(52) U.S. Cl. 428/315.9; 428/317.9; 428/319.3

(57) ABSTRACT

In accordance with the present invention, compositions and methods are provided in which a layered low dielectric constant nanoporous material is produced that comprises a first layer juxtaposing a substrate; a second nanoporous layer juxtaposing the first layer; and an additional layer juxtaposing the second layer. The layered dielectrics of the present invention are formed using nanoporous materials by a) depositing a first layer on a substrate; b) depositing a second layer that is nanoporous and that juxtaposes the first layer; c) treating the second layered material to produce nanoporosity; and d) depositing at least one additional layer that partially juxtaposes the second layer. A layer of wires or other electronic components can also be situated between the substrate layer and the first layer.

### FIELD OF THE INVENTION

The field of the invention is nanoporous materials.

### BACKGROUND

As the size of functional elements in integrated circuits decreases, complexity and interconnectivity increases. To accommodate the growing demand of interconnections in modern integrated circuits, on-chip interconnections have been developed. Such interconnections generally consist of multiple layers of metallic conductor lines embedded in a low dielectric constant material. The dielectric constant in such material has a very important influence on the performance of an integrated circuit. Materials having low dielectric constants (i.e., below 2.5) are desirable because they allow faster signal velocity and shorter cycle times. In general, low dielectric constant materials reduce capacitive effects in integrated circuits, which frequently leads to less cross talk between conductor lines, and allows for lower voltages to drive integrated circuits.

Low dielectric constant materials can be characterized as predominantly inorganic or organic. Inorganic oxides often have dielectric constants between 2.5 and 4, which tends to become problematic when device features in integrated circuits are smaller than 1 μm. Organic polymers include epoxy networks, cyanate ester resins, polyarylene ethers, and polyimides. Epoxy networks frequently show disadvantageously high dielectric constants at about 3.8-4.5. Cyanate ester resins have relatively low dielectric constants between approximately 2.5-3.7, but tend to be rather brittle, thereby limiting their utility. Polyimides and polyarylene ethers have shown many advantageous properties including high thermal stability, ease of processing, low stress, low dielectric constant and high resistance, and such polymers are therefore frequently used as alternative low dielectric constant polymers.

With respect to other properties, desirable dielectrics should also be free from moisture and out-gassing problems, have suitable adhesive and gap-filling qualities, and have suitable dimensional stability towards thermal cycling, etching, and CMP processes (i.e., chemical, mechanical, polishing). Preferred dielectrics should also have Tg values (glass transition temperatures) of at least 300° C., and preferably 400° C. or more.

The demand for materials having dielectric constant lower than 2.5 has led to the development of dielectric materials with designed-in nanoporosity. Since air has a dielectric constant of about 1.0, a major goal is to reduce the dielectric constant of nanoporous materials down towards a theoretical limit of 1. Several approaches are known in the art for fabricating nanoporous materials, including U.S. Pat. No. 5,458,709 issued to Kamezaki and U.S. Pat. No. 5,593,526 issued to Yokouchi. Copending applications, Ser. Nos. 09/538,276; 09/544,722; 09/544,723; 09/544,504; and 09/420611 also address approaches for fabricating nanoporous materials. In these applications, it is disclosed that nanoporous materials can be fabricated a) from polymers having backbones with reactive groups used in crosslinking; b) from polymer strands having backbones that are crosslinked using ring structures; and c) from stable, polymeric template strands having reactive groups that can be used for adding thermolabile groups or for crosslinking; d) by depositing cyclic oligomers on a substrate of the device, including the cyclic oligomers in a polymer, and crosslinking the polymer to form a crosslinked polymer; and e) by using a dissolvable phase to form a polymer.

Regardless of the approach used to introduce the voids, structural problems are frequently encountered in fabricating and processing nanoporous materials. Among other things, increasing the porosity beyond a critical extent (generally about 30% in the known nanoporous materials) tends to cause the porous materials to be weak and in some cases to collapse in single-layer dielectric applications. Collapse can be prevented to some degree by adding crosslinking additives to the starting material that couple thermostable portions with other thermostable portions, thereby producing a more rigid single-layer dielectric network. However, the porous material, even after cross-linking, can lose mechanical strength as the porosity increases, and the material will be unable to survive during integration of the dielectric film to a circuit. Also, the porous material, even after cross-linking, can lose mechanical strength by not having external support by additional coupled nanoporous layers. U.S. Pat. No. 5,635,301 issued to Kondo et al. (June 1997) (“Kondo”) describes a multi-layered glass substrate having a low dielectric constant comprising a first layer of relatively dense crystalline glass, sandwiched between two layers of a second, relatively porous glass. The arrangement of layers of glass in Kondo is designed to provide additional external strength and support to the individual porous glass layers. Kondo, however, teaches that the chemical composition of the material that forms each layer of the multi-layered glass substrate must be identical to every other layer.

Therefore, there is a need to provide methods and compositions to produce layered dielectric materials comprising various nanoporous low dielectric materials that can combine porosity with thermal and structural durability and exemplary gap-filling properties.

### SUMMARY OF THE INVENTION

In accordance with the present invention, compositions and methods are provided in which a layered low dielectric constant nanoporous material is produced that comprises a first layer juxtaposing a substrate, wherein the first layer may be continuous or nanoporous; a second layer juxtaposing the first layer and is nanoporous; and an additional layer partially juxtaposing the second layer.

The layered dielectrics of the present invention are formed using nanoporous materials by a) depositing a first layer on a substrate; b) depositing a second layer that juxtaposes the first layer; c) treating the second layered material to create nanoporosity in the layer; and d) depositing at least one additional layer that partially juxtaposes the second layer. The first layer can optionally be treated to create nanoporosity in the layer.

In preferred embodiments, at least one of the layers comprises a substantially organic nanoporous material. In yet other preferred embodiments, each layer comprises nanoporous material.

In yet other preferred embodiments, a layer of wires or other electronic components is situated between the substrate layer and the first layer.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a cross-sectional view of a preferred embodiment.

FIG. 2 shows a cross-sectional view of a preferred embodiment.

FIG. 3 shows a cross-sectional view of a preferred embodiment.

FIG. 4 shows a flowchart of a preferred method for producing layered nanoporous dielectric materials.

### DETAILED DESCRIPTION

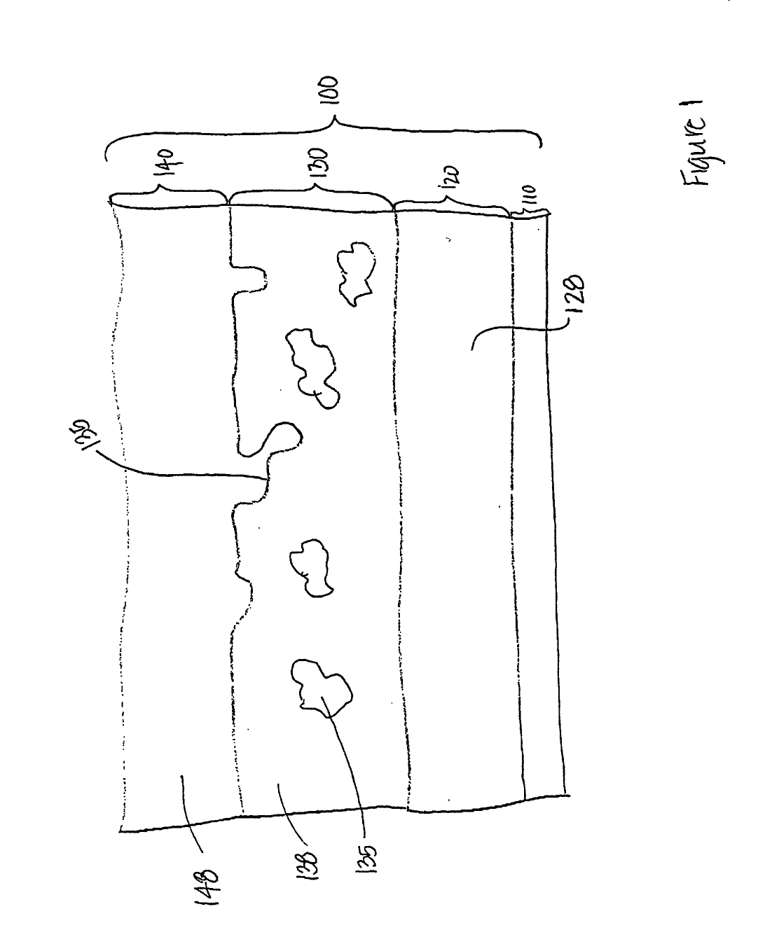

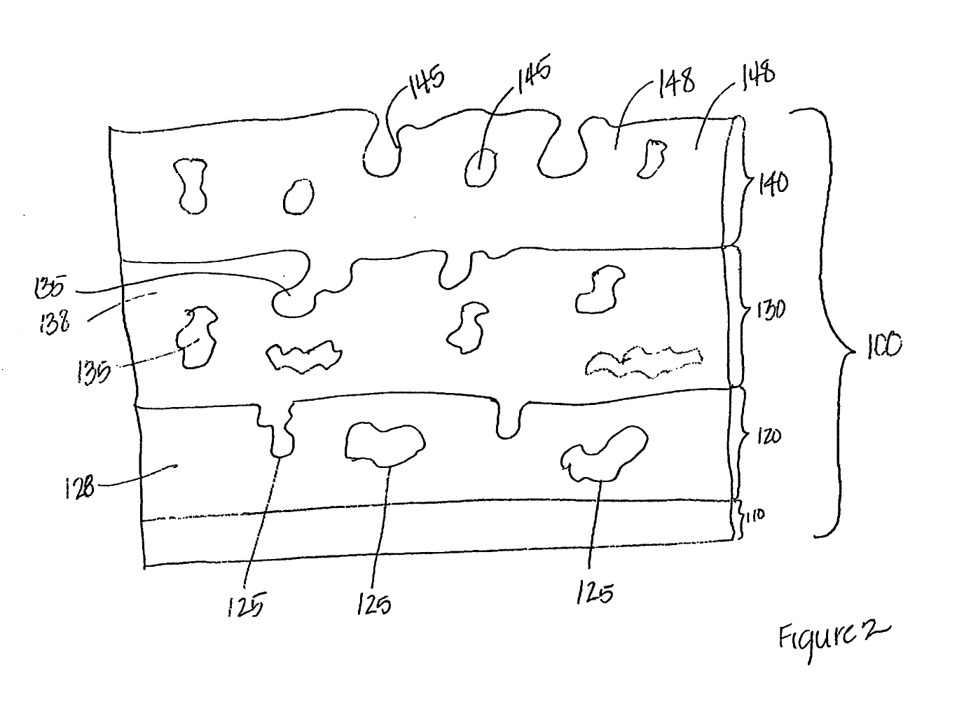

In FIGS. 1 and 2, described in greater detail below, a layered stack 100 includes a substrate 110, a first layer 120, a second nanoporous layer 130, and an additional layer 140. In preferred embodiments, the first layer 120 in layered stack 100 includes either a continuous layer of non-volatile component 128 (FIG. 1) or voids 125 and a non-volatile component 128 (FIG. 2). The second layer 130 in layered stack 100 includes voids 135 and non-volatile component 138. The additional layer 140 in layered stack 100 may include voids 145 and non-volatile component 148.

As used herein, the term “nanoporous layer” refers to any suitable low dielectric material (i.e. ≦3.0) that is composed of a plurality of voids and a non-volatile component. As used herein, the term “substantially” means a desired component is present in a layer at a weight percent amount greater than 51%.

Substrates 110 contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and copper oxides), a polymer-based packaging or board interface such as found in a polyimide-based flex package, lead or other metal alloy solder ball surface, glass and polymers such as polymimide, BT, and FR4. In more preferred embodiments, the substrate comprises a material common in the packaging and circuit board industries such as silicon, copper, glass, or suitable polymer.

The first layer 120 can be designed to satisfy several design goals, such as smoothing and/or protecting the substrate 110, providing support for a second nanoporous layer 130, filling gaps (“gap-filling”) around wires or other electronic components situated on the substrate 110, and providing an additional and sometimes different dielectric material layer. It is contemplated that the non-volatile component 128 of the first layer 120 can be selected in order to accommodate the design goals of the first layer 120. The non-volatile component 128 can be composed of organic, inorganic or organometallic compounds. Examples of contemplated organic compounds are polyethers, polyarylene ethers, polyimides or polyesters. Examples of contemplated organometallic compounds include poly(dimethylsiloxane), poly(vinylsiloxane) and poly(trifluoropropylsiloxane). Examples of contemplated inorganic compounds include refractory ceramic materials, such as silicon nitride, silicon oxynitride, and silicon carbide.

The non-volatile component 128 may also include substantially polymeric material, substantially monomeric material or a mixture of both polymers and monomers depending on the desired final dielectric composition, desired electrical properties, and desired use of the dielectric material. It is further contemplated that non-volatile component 128 may be composed of amorphous, cross-linked, crystalline, or branched polymers. Preferred components of non-volatile component 128 are organic polymers partly because of their ready availability and ease of use. More preferred components of non-volatile component 128 are organic, cross-linked polymers because of the above-mentioned properties along with increased durability and polymer strength.

The non-volatile component 128 may also include “cage structures” or “cage monomers”, such as those contemplated in U.S. application Ser. No. 09/545,058 which is incorporated herein in its entirety. The term “cage structure” or “cage monomer” refers to a molecule having at least 10 atoms arranged such that at least one bridge covalently connects two or more atoms of a ring system. The bridge and/or the ring system may comprise one or more heteroatoms, and may be aromatic, partially saturated, or unsaturated. Contemplated cage structures include fullerenes, and crown ethers having at least one bridge. For example, an adamantane or diamantane is considered a cage structure, while a naphthalene or an aromatic spirocompound are not considered a cage structure under the scope of this definition, because a naphthalene or an aromatic spirocompound do not have one or more than one bridge.

The first layer 120 may comprise a volatile component 126 along with the nonvolatile component 128. The volatile component 126 can be present in the first layer 120 for several reasons, including solvation of the non-volatile component 128, creation of voids 125 upon curing or heat treatment, and/or aiding deposition of the first layer onto the substrate 110. The volatile component 126 may comprise any suitable pure or mixture of organic, organometallic or inorganic molecules that are volatilized at a desired temperature, and may also comprise any suitable pure or mixture of polar and non-polar compounds. In preferred embodiments, the volatile component 126 comprises water, ethanol, propanol, acetone, ethylene oxide, benzene, cyclohexanone and anisole. In more preferred embodiments, the volatile component 126 comprises water, ethanol, propanol, cyclohexanone and acetone. In even more preferred embodiments, the volatile component 126 comprises a mixture of water, ethanol, propanol, and acetone, because of their availability, low toxicity, and ease of use.

The term “pure” with respect to any of the components contemplated herein means that the component that has a constant composition. For example, pure water is composed solely of H₂O. As used herein, the term “mixture” means that component that is not pure, including salt water. The term “polar” means that characteristic of a molecule or compound that creates an unequal charge distribution at one point of or along the molecule or compound. The term “non-polar” means that characteristic of a molecule or compound that creates an equal charge distribution at one point of or along the molecule or compound.

The volatile component 126 may comprise any appropriate percentage of the first layer 120 that would provide a desirable viscosity of the non-volatile component 128 and the volatile component 126. In preferred embodiments, the volatile component 126 comprises that part of the first layer 120 that is slightly more than is necessary to solvate the non-volatile component 128. In more preferred embodiments, the volatile component 126 comprises that part of the first layer 120 that is necessary to solvate the non-volatile component 128.

The term “crosslinking” refers to a process in which at least two molecules, or two portions of a long molecule, are joined together by a chemical interaction. Such interactions may occur in many different ways, including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

The phrase “dielectric constant” means a dielectric constant evaluated at 1 MHz to 2 GHz, unless otherwise inconsistent with context. It is contemplated that the value of the dielectric constant of the first layer 120 is less than 3.0. In a preferred embodiment, the value of the dielectric constant is less than 2.5, and in still more preferred embodiments, the value of the dielectric constant is less than 2.0.

As used herein, the word “void” means a volume in which a mass is replaced with a gas. The composition of the gas is generally not critical, and appropriate gases include relatively pure gases and mixtures thereof, including air. It is contemplated that the first layer 120 may comprise a plurality of voids 125 or may be continuous and void-free. Voids 125 are typically spherical, but may alternatively or additionally have any suitable shape, including tubular, lamellar, discoidal, or other shapes. It is also contemplated that voids 125 may have any appropriate diameter. It is further contemplated that at least some voids 125 may connect with adjacent voids 125 to create a structure with a significant amount of connected or “open” porosity. Voids 125 preferably have a mean diameter of less than 1 micrometer, and more preferably have a mean diameter of less than 100 nanometers, and still more preferably have a mean diameter of less than 10 nanometers. It is further contemplated that voids 125 may be uniformly or randomly dispersed within the first layer 120. In a preferred embodiment, voids 125 are uniformly dispersed within the first layer 120.

Nanoporosity or voids, in general as contemplated herein, may be created by heating or otherwise curing the combination of the volatile component 126 and the nonvolatile component 128 in order to drive off or evaporate part of or the entire volatile component 126. Leaching an inorganic component, such as those components containing silicon (colloidal silica, a fused silica, a sol-gel derived monosize silica, a siloxane, or a silsesquioxane) or fluorine (HF, CF₄, NF₃, CH_{z}F_{4-z} and C₂HₓF_{y}, wherein x is an integer between 0 and 5, x+y is 6, and z is an integer between 0 and 3) from an organic component in the layer where voids are desirable may also create nanoporosity.

As with the first layer 120, the second nanoporous layer 130 can be designed to satisfy several design goals, such as providing support for the first layer 120 and the additional layer 140, while maintaining a high degree of porosity, however, its primary purpose is to provide a structure containing a high degree of porosity. The non-volatile component 138 of the second layer 130 can be selected in order to accommodate the previously mentioned design goals of the second layer 130. The non-volatile component 138 may also comprise materials similar to those materials contemplated for non-volatile component 128, including inorganic, organic, or organometallic compounds, as well as mixtures of these materials and polymers, monomers and/or cage structures. Examples of contemplated inorganic compounds are silicates, aluminates and compounds containing transition metals. Examples of organic compounds include polyarylene ether, polyimides, adamantane molecules, branched adamantane structures, and polyesters. Examples of contemplated organometallic compounds include poly(dimethylsiloxane), poly(vinylsiloxane) and poly(trifluoropropylsiloxane).

The second layer 130 may comprise a plurality of voids 135 similar in some respects to the first layer 120. Voids 135 are typically spherical, but may alternatively or additionally have any suitable shape, including tubular, lamellar, discoidal, or other shapes. It is also contemplated that voids 135 may have any appropriate diameter. It is further contemplated that at least some voids 135 may connect with adjacent voids 135 to create a structure with a significant amount of connected or “open” porosity. Voids 135 preferably have a mean diameter of less than 1 micrometer, and more preferably have a mean diameter of less than 100 nanometers, and still more preferably have a mean diameter of less than 10 nanometers. It is further contemplated that voids 135 may be uniformly or randomly dispersed within the second layer 130. In a preferred embodiment, voids 135 are uniformly dispersed within the second layer 130.

As with the non-volatile components of the first and second layers, the nonvolatile component 148 of the additional layer 140 can be composed of materials contemplated and described previously depending on the desired structural or design goals. Examples of contemplated organic compounds are polyethers, polyarylene ethers, adamantane molecules, branched adamantane structures, polyimides or polyesters. Examples of contemplated inorganic compounds include silicate or aluminate. Examples of contemplated organometallic compounds include poly(dimethylsiloxane), poly(vinylsiloxane) and poly(trifluoropropylsiloxane).

The non-volatile component 148 may also include both polymers and monomers. It is further contemplated that the non-volatile component 148 may be composed of amorphous, cross-linked, crystalline, or branched polymers. Preferred components of the non-volatile component 148 are organic polymers. More preferred components of the non-volatile component 148 are organic, cross-linked polymers.

As with the first layer 120 and especially the second layer 130, the additional layer 140 may comprise a plurality of voids 145. The voids 145 preferably have a mean diameter of less than 1 micrometer, and more preferably have a mean diameter of less than 100 nanometers, and still more preferably have a mean diameter of less than 10 nanometers. It is further contemplated that the voids 145 may be uniformly or randomly dispersed within the additional layer 140. In a preferred embodiment, the voids 145 are uniformly dispersed within the additional layer 140.

The additional layer 140 may also comprise the non-volatile component 148 that is substantially free of voids 145. In preferred embodiments, the process of forming a void-free additional layer 140 would be used to infiltrate the last applied nanoporous layer in order to reinforce the strength of the underlying nanoporous material by coating the surfaces containing the voids with a thin layer of nonvolatile component 148. The technique of applying an infiltrating layer in this manner is fully described in U.S. patent application Ser. No. 09/420,042, and is incorporated in its entirety herein.

The organic and inorganic materials described herein are similar in some respects to that which is described in U.S. Pat. No. 5,874,516 to Burgoyne et al. (February 1999), incorporated herein by reference, and may be used in substantially the same manner as set forth in that patent. For example, it is contemplated that the organic and inorganic materials described herein may be employed in fabricating electronic chips, chips, and multichip modules, interlayer dielectrics, protective coatings, and as a substrate in circuit boards or printed wiring boards. Moreover, films or coatings of the organic and inorganic materials described herein can be formed by solution techniques such as spraying, spin coating or casting, with spin coating being preferred. Preferred solvents are 2-ethoxyethyl ether, cyclohexanone, cyclopentanone, toluene, xylene, chlorobenzene, N-methyl pyrrolidinone, N,N-dimethylformamide, N,N-dimethylacetamide, methyl isobutyl ketone, 2-methoxyethyl ether, 5-methyl-2-hexanone, Y -butyrolactone, and mixtures thereof. Typically, the coating thickness is between about 0.1 to about 15 microns. As a dielectric interlayer, the film thickness is typically less than 2 microns. Additives can also be used to enhance or impart particular target properties, as is conventionally known in the polymer art, including stabilizers, flame retardants, pigments, plasticizers, surfactants, and the like. Compatible or non-compatible polymers can be blended in to give a desired property. Adhesion promoters can also be used. Such promoters are typified by hexamethyidisilazane, which can be used to interact with available hydroxyl functionality that may be present on a surface, such as silicon dioxide, that was exposed to moisture or humidity. Polymers for microelectronic applications desirably contain low levels (generally less than 1 ppm, preferably less than 10 ppb) of ionic impurities, particularly for dielectric interlayers.

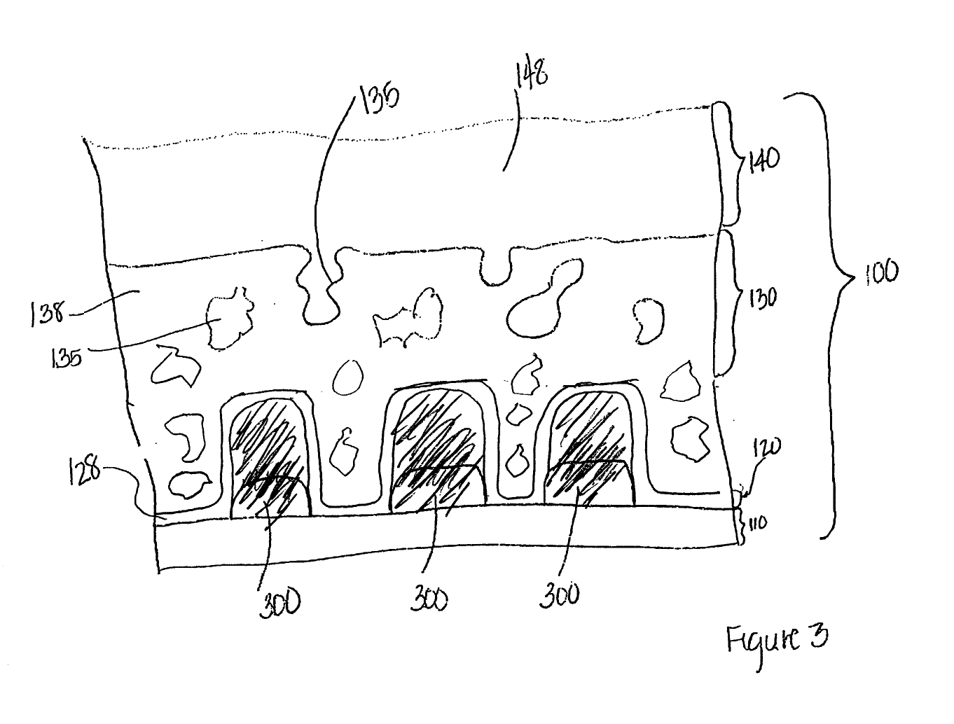

In FIG. 3, wires or other appropriate conductive devices 300 may be placed in between the substrate 110 and the first layer of materials 120. In this instance, the material in the layer directly above the wire layer will act as a protective layer of minimum thickness between the wires and also as a support for any additional layer. Further, the material in the first layer 120 will be continuous and generally not nanoporous when there are wires or other electronic components situated between the substrate 110 and the first layer 120.

The wires, conductive devices, or electronic components 300 can be made from metals or another appropriate conductive material. Suitable metals are those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include titanium, silicon, cobalt, copper, nickel, zinc, vanadium, aluminum, chromium, platinum, gold, silver, tungsten, molybdenum, cerium, promethium, and thorium. More preferred metals include aluminum titanium, silicon, copper, nickel, platinum, gold, silver and tungsten. Most preferred metals include aluminum, titanium, silicon, copper and nickel. The term “metal” also includes alloys, metal/metal composites, metal ceramic composites, metal polymer composites, as well as other metal composites.

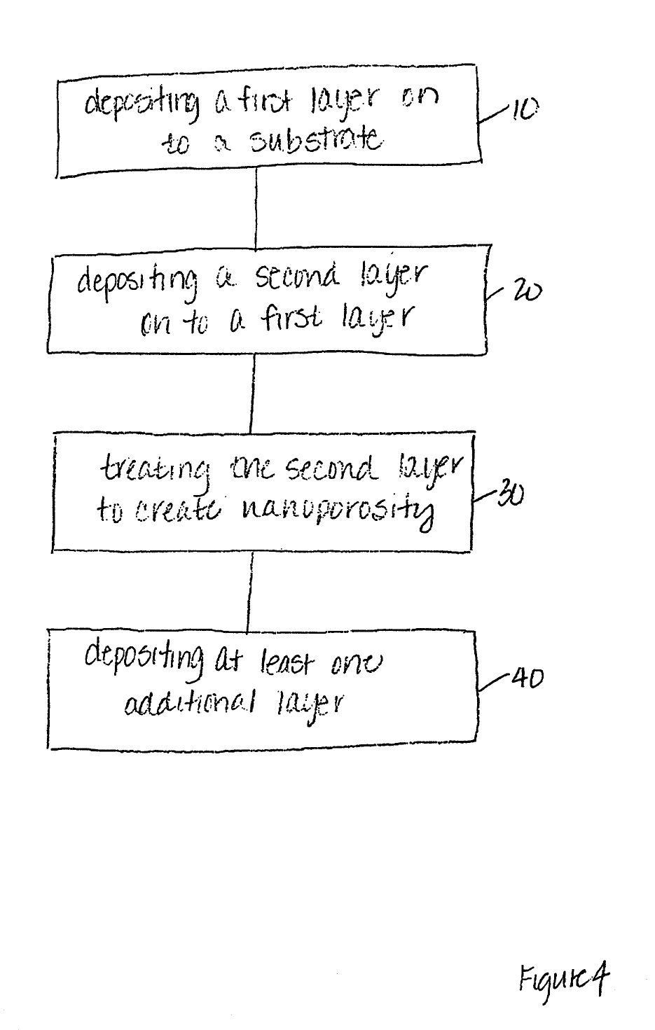

In FIG. 4, described in greater detail below, a preferred method of producing layered nanoporous dielectric materials comprises depositing a first layer 120 onto a substrate 110 (10); depositing a second layer 130 onto the first layer 120 (20); treating the layered material 100 to produce porosity (30); and depositing at least one additional layer 140 onto the second layer 130 (40).

The first layer 120 can be deposited onto a substrate 110 by any suitable method. Contemplated methods include spinning the first layer 120 onto the substrate 110, rolling the first layer 120 onto the substrate 110, dripping the first layer 120 onto the substrate 110, or pouring the first layer 120 onto the substrate 110. In a preferred embodiment, the first layer 120 is rolled or spun onto the substrate 110. It is contemplated that the first layer 120 can be deposited in any suitably sized or shaped deposit. Especially contemplated depositions are thin-film type deposits (<1 mm); however, other depositions including thick-film (≧1 mm), or stand-alone deposits are also contemplated.

The second layer 130 and additional layer 140 can be deposited directly onto the first layer 120 by any suitable method including those methods described for the first layer 120.

Any excess non-volatile component 148 of the additional layer 140 can then be optionally, partially, or completely removed from the layered stack 100 by any suitable removal apparatus or methods. It is contemplated that removal can include spinning off excess non-volatile component 148, or rinsing off excess non-volatile component 148 with an appropriate solvent. Suitable solvents may include cyclohexanone, anisole, toluene, ether or mixtures of compatible solvents. It is further contemplated that there may not be excess non-volatile component 148, and thus, there will be no need for a non-volatile component removal step. As used herein, the phrase “any excess” does not suggest or imply that there is necessarily any excess non-volatile component 148.

The volatile component 146 can be removed from the additional layer 140 by any suitable removal procedure, including heat and/or pressure. In preferred embodiments, the volatile component 146 can be removed by heating the additional layer 140 or the layered stack 100. In more preferred embodiments, the volatile component 146 is removed by heating the additional layer 140 or the layered stack 100 in a gaseous environment at atmospheric pressure. In other preferred embodiments, the volatile component 146 is removed by heating the additional layer 140 or layered stack in a gaseous environment at sub-atmospheric pressure. As used herein, the phrase “sub-atmospheric pressure” means that pressure that has a value lower than 760 atmospheres. As used herein, the phrase “atmospheric pressure” means that pressure that has a value of 760 atmospheres. As used herein, the phrase “gaseous environment” means that environment that contains pure gases, including nitrogen, helium, or argon; or mixed gases, including air.

The layered stack 100 can be cured to its final form before or after any excess additional component 148 is removed from the additional layer 140. Although in preferred embodiments the layered stack 100 is cured using heat, many other methods are contemplated, including catalyzed and uncatalyzed methods. Catalyzed methods may include general acid- and base catalysis, radical catalysis, cationic- and anionic catalysis, and photocatalysis. For example, a polymeric structure may be formed by UV-irradiation, addition of radical starters, such as ammoniumpersulfate, and addition of acid or base. Uncatalyzed methods include application of pressure, or application of heat at subatmospheric, atmospheric or super-atmospheric pressure.

### EXAMPLES

### Example 1

Five mL of 4 wt. % polyarylene ether in cyclohexanone is dispensed onto a silicon wafer, followed by 3 seconds spread at 150 RPM, 50 seconds at 0 RPM, and 60 seconds at 2000 RPM. The first film layer is then baked at 80° C., 150° C., and 250° C. for one minute each, followed by curing at 400° C. for 30 minutes in nitrogen. This procedure was repeated to prepare three coated wafers: A, B, and C.

A spinning solution containing 9.6 wt % polyarylene ether, 6.4 wt % colloidal silica and 84 wt % cyclohexanone can be used to form a low dielectric structural layer on a first film layer that is approximately 8000 Angstroms in thickness and in the form of a film. The film can then be baked at 150/200/250° C. for 1 minute each and cured at 400° C. for 60 minutes in nitrogen. The post-cure film can be etched with BOE 50:1 solution for 3 minutes to remove the silica. After etching, >98% of the silica is removed, and the post-etch film is a porous polyarylene ether. The refractive index of the post-etch film is about 1.474 with a thickness of approximately 7800 Angstroms. The dielectric constant of the structural layer is about 2.06. Three wafers, A, B and C, were prepared as described above in this manner.

A stud pull test was conducted using a Sebastian Five stud pull tester manufactured by Quad group. The cured, coated wafer is first processed to deposit a dense, 1-micron thick layer of aluminum on the surface of the structural material. The layered stack was cut into multiple pieces of about a 1 cm×1 cm each. A ceramic backing plate with epoxy coating was attached to the non-infiltrated side of the test pieces. Studs, which are metal pins with epoxy coating on the tip of the pin, were attached to the film of the test piece. The backing plate, test piece and the stud were then clipped together by a metal clip. This procedure is called the stud assembly. The assembled pieces were cured in an oven at 130° C. for 2 hours. After curing the epoxy, the stud, test piece and backing plate were glued together. The end of the stud was then inserted into the Quad group, Sebastian Five, stud pull tester. Pulling force was applied to the stub until the assembled piece broke. Maximum strength achieved, in Kpsi, recorded during the test was taken as the stud pull strength of the film for that piece. Typically, at least ten pieces from a specimen are tested. The stud pull strength reported is the mean value of the measurements. The stud pull strength of wafer A is about 2 Kpsi. Wafer A is not infiltrated.

About 5 mL of 4 wt % polyarylene ether solution in cyclohexanone is dispensed onto the post-etch film of Wafer B described above [infiltrated but no top layer]. The wafers were spun at 200 RPM for five seconds and then stopped. Once the polyarylene ether solution has rested on top of the film for 15 seconds, the layered stack is spun at approximately 2000 RPM. After the spinning step, about 9 mL of cyclohexanone is dispensed onto the film and then a second spin at 2000 RPM is used to rinse off the excess resin in a spin coater operation. The infiltrated and rinsed layered stack is then baked on hot plates at 150/200/250° C. for one minute each to remove the cyclohexanone. The infiltrated material is then cured at 400° C. for 60 minutes, thus forming the final infiltrated low dielectric structural layer.

The dielectric constant of the infiltrated layer was 2.12 with a refractive index of 1.494 and a film thickness of about 7800 Angstroms. Scanning Electron Microscopy (SEM) showed that there was no infiltrating layer on top of the structural layer. The stud pull strength of wafer B was 6 Kpsi.

Wafer C was processed in the same manner as wafer B except that the cyclohexanone rinse step was omitted. The dielectric constant of this film was 2.2 with a refractive index of 1.521. SEM analysis showed that a continuous, non-porous film of about 1500 Angstroms was on top of the nanoporous layer. The stud pull strength of wafer C was 9 Kpsi.

### Example 2

Wafer D was prepared in exactly the same manner as Wafer C in Example 1, except that the first film layer, the continuous polyarylene ether, was not deposited. The stud pull strength of the completed structure was 8 Kpsi.

### Example 3

Three silicon wafers that had been separately processed to incorporate fine aluminum wire structures typical of that used in integrated circuits were processed in three ways. Wafer E was processed in a manner identical to the procedure used to process Wafer C in Example 1. Wafer F was processed in a manner identical to the procedure used to produce Wafer D of Example 2. Wafer G was processed in a manner similar to Wafer C except that the first step of depositing the polyarylene ether layer was replaced by depositing a 500 Angstroms layer of silicon nitride using a CVD technique.

SEM analysis of Wafer F showed that the fine aluminum wires were severely etched leaving large voids in the film structure. SEM analysis of wafers E and G showed that the aluminum wires were left in tact.

### Example 4

Five mL of 4 wt. % of an adamantane-based compound, in cyclohexanone is dispensed onto a silicon wafer, followed by 3 seconds spread at 150 RPM, 50 seconds at 0 RPM, and 60 seconds at 2000 RPM. The first film layer is then baked at 80° C., 150° C., and 250° C. for one minute each, followed by curing at 400° C. for 30 minutes in nitrogen. This procedure was repeated to prepare three coated wafers: H, I, and J.

A spinning solution containing 9.6 wt % polyarylene ether, 6.4 wt % colloidal silica and 84 wt % cyclohexanone can be used to form a low dielectric structural layer on a first film layer that is approximately 8000 Angstroms in thickness and in the form of a film. The film can then be baked at 150/200/250° C. for 1 minute each and cured at 400° C. for 60 minutes in nitrogen. The post-cure film can be etched with BOE 50:1 solution for 3 minutes to remove the silica. After etching, >98% of the silica is removed, and the post-etch film is a porous polyarylene ether of approximately 7800 Angstroms. The dielectric constant of the structural layer is about 1.92. Wafers H, I and J were treated in this manner.

A stud pull test was conducted using a Sebastian Five stud pull tester manufactured by Quad group. The cured, coated wafer is first processed to deposit a dense, 1-micron thick layer of aluminum on the surface of the structural material. The layered stack was cut into multiple pieces of about a 1 cm×1 cm each. A ceramic backing plate with epoxy coating was attached to the non-infiltrated side of the test pieces. Studs, which are metal pins with epoxy coating on the tip of the pin, were attached to the film of the test piece. The backing plate, test piece and the stud were then clipped together by a metal clip. This procedure is called the stud assembly. The assembled pieces were cured in an oven at 130° C. for 2 hours. After curing the epoxy, the stud, test piece and backing plate were glued together. The end of the stud was then inserted into the Quad group, Sebastian Five, stud pull tester. Pulling force was applied to the stub until the assembled piece broke. Maximum strength achieved, in Kpsi, recorded during the test was taken as the stud pull strength of the film for that piece. Typically, at least ten pieces from a specimen are tested. The stud pull strength reported is the mean value of the measurements. The stud pull strength of wafer H is about 2 Kpsi. Wafer H is not infiltrated.

About 5 mL of 4 wt % polyarylene ether solution in cyclohexanone is dispensed onto the post-etch film of Wafer I described above [infiltrated but no top layer]. The wafers were spun at 200 RPM for five seconds and then stopped. Once the polyarylene ether solution has rested on top of the film for 15 seconds, the layered stack is spun at approximately 2000 RPM. After the spinning step, about 9 mL of cyclohexanone is dispensed onto the film and then a second spin at 2000 RPM is used to rinse off the excess resin in a spin coater operation. The infiltrated and rinsed layered stack is then baked on hot plates at 150/200/250° C. for one minute each to remove the cyclohexanone. The infiltrated material is then cured at 400° C. for 60 minutes, thus forming the final infiltrated low dielectric structural layer.

The dielectric constant of the infiltrated layer was 2.12 with a refractive index of 1.494 and a film thickness of about 7800 Angstroms. Scanning Electron Microscopy (SEM) showed that there was no infiltrating layer on top of the structural layer. The stud pull strength of wafer I was 6 Kpsi.

Wafer J was processed in the same manner as wafer I except that the cyclohexanone rinse step was omitted. The dielectric constant of this film was 2.2 with a refractive index of 1.521. SEM analysis showed that a continuous, non-porous film of about 1500 Angstroms was on top of the nanoporous layer. The stud pull strength of wafer J was 9 Kpsi.

### Example 5

Wafer K was prepared in exactly the same manner as Wafer J in Example 4, except that the first film layer, the continuous adamantane-based compound, was not deposited. The stud pull strength of the completed structure was 8 Kpsi.

### Example 6

Two silicon wafers L and M were separately processed to incorporate fine aluminum wire structures typical of those used in integrated circuits. The distance between adjacent aluminum wires/lines, normally called gaps, ranged from about 0.1 to >1.0 micron. The height of the aluminum structures was about 0.7 micron.

Wafer L was processed in the same way as wafer G in Example 3. Wafer M was processed in the same manner as wafer L except that the adamantane-based compound was used in place of the polyarylene ether in the formulation of the second layer and the additional layer.

Both wafers were examined by SEM to determine if the nanoporous polymer of the second layer filled the gaps between the aluminum wires/lines. Wafer M showed that all gaps, including those less than 0.1 micron were completely filled. On the other hand, wafer L incorporating the polyarylene ether material did not fill gaps smaller than about 0.25 micron.

### Example 7

Five mL of 4 wt. % of an adamantane-based compound, in cyclohexanone is dispensed onto a silicon wafer, followed by 3 seconds spread at 150 RPM, 50 seconds at 0 RPM, and 60 seconds at 2000 RPM. The first film layer is then baked at 80° C., 150° C., and 250° C. for one minute each, followed by curing at 400° C. for 30 minutes in nitrogen. This procedure was repeated to prepare three coated wafers: N, O, and P.

A spinning solution containing 9.6 wt % of the adamantane-based compound, 6.4 wt % colloidal silica and 84 wt % cyclohexanone can be used to form a low dielectric structural layer on a first film layer that is approximately 8000 Angstroms in thickness and in the form of a film. The film can then be baked at 150/200/250° C. for 1 minute each and cured at 400° C. for 60 minutes in nitrogen. The post-cure film can be etched with BOE 50:1 solution for 3 minutes to remove the silica. After etching, >98% of the silica is removed, and the post-etch film is a porous adamantane-based compound with a thickness of approximately 7800 Angstroms. The dielectric constant of the structural layer is about 1.92. Three wafers were prepared and designated as N, O and P.

A stud pull test was conducted using a Sebastian Five stud pull tester manufactured by Quad group. The cured, coated wafer is first processed to deposit a dense, 1-micron thick layer of aluminum on the surface of the structural material. The layered stack was cut into multiple pieces of about a 1 cm×1 cm each. A ceramic backing plate with epoxy coating was attached to the non-infiltrated side of the test pieces. Studs, which are metal pins with epoxy coating on the tip of the pin, were attached to the film of the test piece. The backing plate, test piece and the stud were then clipped together by a metal clip. This procedure is called the stud assembly. The assembled pieces were cured in an oven at 130° C. for 2 hours. After curing the epoxy, the stud, test piece and backing plate were glued together. The end of the stud was then inserted into the Quad group, Sebastian Five, stud pull tester. Pulling force was applied to the stub until the assembled piece broke. Maximum strength achieved, in Kpsi, recorded during the test was taken as the stud pull strength of the film for that piece. Typically, at least ten pieces from a specimen are tested. The stud pull strength reported is the mean value of the measurements. The stud pull strength of wafer N is about 2 Kpsi. Wafer N is not infiltrated.

About 5 mL of 4 wt % polyarylene ether solution in cyclohexanone is dispensed onto the post-etch film of Wafer O described above [infiltrated but no top layer]. The wafers were spun at 200 RPM for five seconds and then stopped. Once the polyarylene ether solution has rested on top of the film for 15 seconds, the layered stack is spun at approximately 2000 RPM. After the spinning step, about 9 mL of cyclohexanone is dispensed onto the film and then a second spin at 2000 RPM is used to rinse off the excess resin in a spin coater operation. The infiltrated and rinsed layered stack is then baked on hot plates at 150/200/250° C. for one minute each to remove the cyclohexanone. The infiltrated material is then cured at 400° C. for 60 minutes, thus forming the final infiltrated low dielectric structural layer.

The dielectric constant of the infiltrated layer was 1.97 and a film thickness of about 7800 Angstroms. Scanning Electron Microscopy (SEM) showed that there was no infiltrating layer on top of the structural layer. The stud pull strength of wafer O was 6 Kpsi.

Wafer P was processed in the same manner as wafer O except that the cyclohexanone rinse step was omitted. The dielectric constant of this film was 2.05. SEM analysis showed that a continuous, non-porous film of about 1500 Angstroms was on top of the nanoporous layer. The stud pull strength of wafer P was 9 Kpsi.

### Example 8

Five mL of 4 wt. % of an adamantane-based compound, in cyclohexanone is dispensed onto a silicon wafer, followed by 3 seconds spread at 150 RPM, 50 seconds at 0 RPM, and 60 seconds at 2000 RPM. The first film layer is then baked at 80° C., 150° C., and 250° C. for one minute each, followed by curing at 400° C. for 30 minutes in nitrogen. This procedure was repeated to prepare three coated wafers: Q, R, and S.

A spinning solution containing 9.6 wt % an adamantane-based compound, 6.4 wt % colloidal silica and 84 wt % cyclohexanone can be used to form a low dielectric structural layer on a first film layer that is approximately 8000 Angstroms in thickness and in the form of a film. The film can then be baked at 150/200/250° C. for 1 minute each and cured at 400° C. for 60 minutes in nitrogen. The post-cure film can be etched with BOE 50:1 solution for 3 minutes to remove the silica. After etching, >98% of the silica is removed, and the post-etch film is a porous adamantane-based compound layer. The post-etch film has a thickness of approximately 7800 Angstroms. The dielectric constant of the structural layer is about 1.92. Three wafers were prepared: Q, R and S.

A stud pull test was conducted using a Sebastian Five stud pull tester manufactured by Quad group. The cured, coated wafer is first processed to deposit a dense, 1-micron thick layer of aluminum on the surface of the structural material. The layered stack was cut into multiple pieces of about a 1 cm×1 cm each. A ceramic backing plate with epoxy coating was attached to the non-infiltrated side of the test pieces. Studs, which are metal pins with epoxy coating on the tip of the pin, were attached to the film of the test piece. The backing plate, test piece and the stud were then clipped together by a metal clip. This procedure is called the stud assembly. The assembled pieces were cured in an oven at 130° C. for 2 hours. After curing the epoxy, the stud, test piece and backing plate were glued together. The end of the stud was then inserted into the Quad group, Sebastian Five, stud pull tester. Pulling force was applied to the stub until the assembled piece broke. Maximum strength achieved, in Kpsi, recorded during the test was taken as the stud pull strength of the film for that piece. Typically, at least ten pieces from a specimen are tested. The stud pull strength reported is the mean value of the measurements. The stud pull strength of wafer Q is about 2 Kpsi. Wafer Q is not infiltrated.

About 5 mL of 4 wt % of an adamantane-based compound solution in cyclohexanone is dispensed onto the post-etch film of Wafer R described above [infiltrated but no top layer]. The wafers were spun at 200 RPM for five seconds and then stopped. Once the adamantane-based compound solution has rested on top of the film for 15 seconds, the layered stack is spun at approximately 2000 RPM. After the spinning step, about 9 mL of cyclohexanone is dispensed onto the film and then a second spin at 2000 RPM is used to rinse off the excess resin in a spin coater operation. The infiltrated and rinsed layered stack is then baked on hot plates at 150/200/250° C. for one minute each to remove the cyclohexanone. The infiltrated material is then cured at 400° C. for 60 minutes, thus forming the final infiltrated low dielectric structural layer.

The dielectric constant of the infiltrated layer was 1.96 with a refractive index of 1.494 and a film thickness of about 7800 Angstroms. Scanning Electron Microscopy (SEM) showed that there was no infiltrating layer on top of the structural layer. The stud pull strength of wafer R was 6 Kpsi.

Wafer S was processed in the same manner as wafer R except that the cyclohexanone rinse step was omitted. The dielectric constant of this film was 2.0. SEM analysis showed that a continuous, non-porous film of about 1500 Angstroms was on top of the nanoporous layer. The stud pull strength of wafer S was 9 Kpsi.

Thus, specific embodiments and applications of layered nanoporous materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A layered low dielectric constant nanoporous material comprising:
a first layer juxtaposing a substrate;
a second layer that is nanoporous and juxtaposing the first layer; and
an additional layer partially juxtaposing the second layer.

2. The material of claim 1, wherein the low dielectric constant material has a dielectric constant no more than 2.5.

3. The material of claim 1, wherein the first layer substantially comprises a continuous, non-porous polymer.

4. The material of claim 3, wherein the polymer is organic

5. The material of claim 4, wherein the polymer comprises polyarylene ether.

6. The material of claim 1, wherein the first layer substantially comprises a refractory ceramic material.

7. The material of claim 6, wherein the ceramic material is selected from the group consisting of silicon nitride, silicon oxynitride, and silicon carbide.

8. The material of claim 1, wherein the first layer substantially comprises a nanoporous material.

9. The material of claim 1, wherein the first layer substantially comprises an adamantane-based compound.

10. The material of claim 1, wherein the second layer substantially comprises a nanoporous polymer.

11. The material of claim 10, wherein the polymer comprises at least one of a polyarylene ether or an adamantane-based compound.

12. The material of claim 1, wherein the additional layer comprises an organic compound.

13. The material of claim 12, wherein the organic compound substantially comprises at least one of a polyarylene ether or an adamantane-based compound.

14. The material of claim 1, wherein the nanoporous material comprises voids having a mean diameter of less than 100 nanometers.

15. The material of claim 1, further comprising a layer of metal wire between the substrate and the first layer.

16. The material of claim 15, wherein the first layer is continuous.

17. The material of claim 15, wherein the metal wire is aluminum or copper.

18. A method of producing a layered low dielectric constant nanoporous material comprising:
depositing a first layer on a substrate;
depositing at least part of a second layer on the first layer;
treating the second layer to create nanoporosity; and
depositing at least part of an additional layer on the second layer.

19. The method of claim 18, wherein the substrate is a silicon wafer.

20. The method of claim 18, wherein the first layer is treated to create nanoporosity in the layer.

21. The method of claim 18, wherein the low dielectric constant structural layer has a dielectric constant no more than 2.5, the first layer comprises a polymer, the second layer comprises an organic polymer and said additional layer comprises a substantially organic polymer, and containing voids having a mean diameter of less than 100 nanometers.

22 The method of claim 18, wherein the low dielectric constant structural layer has a dielectric constant no more than 2.5, the first layer comprises polyarylene ether, the second layer comprises a polyarylene ether containing voids having a mean diameter of less than 100 nanometers and said additional layer comprises a polyarylene ether.

23 The method of claim 18, wherein the low dielectric constant structural layer has a dielectric constant no more than 2.5, the first layer comprises an adamantane-based compound, the second layer comprises a polyarylene ether containing voids having a mean diameter of less than 100 nanometers and said additional layer comprises at least one of a polyarylene ether or an adamantane-based compound.

24. The method of claim 18, wherein the low dielectric structural layer has a dielectric constant no more than 2.5, the first layer comprises a refractory ceramic material, the second layer comprises an organic polymer containing voids having a mean diameter of less than 100 nanometers, and the additional layer comprises a substantially organic polymer.

25. The method of claim 18, wherein the low dielectric structural layer has a dielectric constant no more than 2.5, the first layer comprises silicon nitride, the second layer comprises polyarylene ether containing voids having a mean diameter of less than 100 nanometers, and the additional layer comprises at least one of a polyarylene ether or an adamantane-based compound.

26. The method of claim 18, wherein the low dielectric structural layer has a dielectric constant no more than 2.5, the first layer comprises silicon nitride, the second layer comprises an adamantane-based compound containing voids having a mean diameter of less than 100 nanometers, and the additional layer comprises at least one of a polyarylene ether or an adamantane-based compound.

27. The method of claim 18, wherein the nanoporosity is created by leaching an inorganic component from an organic component in the second layer.

28. The method of claim 25, wherein the inorganic component comprises silicon.

29. The method of claim 26, wherein the inorganic component is selected from the group consisting of a colloidal silica, a fused silica, a sol-gel derived monosize silica, a siloxane, and a silsesquioxane.

30. The method of claim 25, wherein the inorganic component comprises fluorine.

31. The method of claim 28, wherein the inorganic component is selected from the group consisting of HF, CF₄, NF₃, CH_{z}F_{4-z} and C₂HₓF_{y}, wherein x is an integer between 0 and 5, x+y is 6, and z is an integer between 0 and 3.

32. The method of claim 18, wherein the additional layer is formed from a solution containing a volatile component and an organic polymer that is deposited on the second layer, allowed to at least partially infiltrate the second layer, and heated to remove the volatile component and to cure the polymer.

33. The method of claim 30, wherein the additional layer comprises a solution of polyarylene ether dissolved in cyclohexanone.
